(19) United States
(12) Patent Application Publication
(10) Pub. No.: US 2010/0221071 A1
(43) Pub. Date: Sep. 2, 2010

(54) REMOTELY CONTROLLED MINING MACHINES, CONTROL SYSTEMS, AND RELATED METHODS

(75) Inventors: Gregory E. Hinshaw, Proctorville, OH (US); Henry E. Wilson, Ironton, OH (US)

Correspondence Address: KING & SCHICKLI, PLLC, 247 NORTH BROADWAY, LEXINGTON, KY, 40507, US

(73) Assignee: J. H. FLETCHER & CO, Huntington, WV (US)

(21) Appl. No.: 12/441,149

(22) PCT Filed: Sep. 17, 2007
(86) PCT No.: PCT/US2007/078627

§ 371 Date: Mar. 13, 2009

Related U.S. Application Data
(60) Provisional application No. 60/844,892, filed on Sep. 15, 2006.

(51) Int. Cl. G05B 9/02; G08B 21/00; E21D 21/00

(52) U.S. Cl. 405/259.1; 340/680; 700/275

(57) ABSTRACT

In one aspect, a system assists an operator in controlling a machine, such as a bolter including a drill head for drilling a borehole in a mine passage having a face and installing a bolt therein, as well as possibly a miner for advancing the mine passage. A controller controls the operation of the machine, and a transmitter transmits to the controller control signals from the operator at a remote location from the borehole. A sensor causes the controller to take action, such as by providing a warning signal or disabling one or more aspects of the machine, if the operator is within a predetermined proximity of the drilling, bolting, or mining operation. Systems and methods pertain to other related aspects of the invention.

This application claims the benefit of U.S. Provisional Patent Application Ser. No. 60/844,892, the disclosure of which is incorporated herein by reference.

### COPYRIGHT STATEMENT

A portion of the disclosure of this document contains material subject to copyright protection. No objection is made to the facsimile reproduction of the patent document or this disclosure as it appears in the Patent and Trademark Office files or records, but any and all rights in the copyright(s) are otherwise reserved.

### TECHNICAL FIELD

The present invention relates to the mining arts and, more particularly, to apparatuses, systems, and methods for use in underground mining.

### BACKGROUND OF THE INVENTION

During underground mining, it is a requirement for purposes of safety as well as federal law to install roof support at various intervals. This is often done using a machine known in the vernacular as a “roof' bolter (even though it is capable of installing bolts in faces besides the roof of a mine passage, such as the ribs). Typically, such a roof bolter is capable of both forming (drilling) boreholes in the faces of the passageways of underground mines and then installing roof anchors or “bolts” in the boreholes. Usually, the bolter is employed after a mining machine used to win the coal or other minerals from the mine face is withdrawn from the entry thus formed.

In an effort to improve efficiency and save space in the confines of the underground mine environment, proposals have been made to couple the roof bolting functionality with that of the mining machine. Examples of such combined machines may be found in U.S. Pat. Nos. 4,753,486, 4,953,914, and 6,942,301. However, the requirement for an operator manning the drills in order to perform the bolting operation remains in all of these proposals. This places the operator in an obviously undesirable position (that is, below unsupported roof and along side of a heavy, working drill).

Canopies and other “automated” temporary roof supports (ATRS) have been proposed for alleviating this condition. However, these structures are costly and sometimes take significant time and effort to deploy. Also, since the bolting can be done using a single machine while the miner is recovering the desired material, a limitation is placed on the speed with which the entire operation can be accomplished.

Proposals have also been made in the past for operating mining and drilling machinery by way of remote control (see, e.g., U.S. Pat. Nos. 4,398,850; 4,192,551 and, more recently, 6,871,712). While remote control advantageously removes the operator from the location where the work is occurring, limitations still exist. For one, the use of such control in the past does not prevent the operator from coming within a predetermined proximity of the work location while the machinery is operational.

Accordingly, a need exists for mining apparatuses and related methods of mining that are more efficient and potentially eliminate the exposure of the operator of a bolter to unsupported roof (and, most preferably, without requiring a canopy or other type of temporary roof support). A need also exists for a manner for remotely controlling a drilling or bolting operation, and ceasing the operation if it is determined that the operator comes within a predetermined proximity of the work location. Coupling these and other features of a remote bolter with a miner would also provide numerous advantageous benefits.

### SUMMARY OF THE INVENTION

In accordance with a first aspect of the invention, a system assists an operator in controlling a machine including a drill head for drilling a borehole in a face of a mine passage and installing a bolt therein. The system comprises a controller for controlling the operation of the drilling or bolting machine. A transmitter transmits to the controller control signals from the operator at a remote location from the drill head. One or more sensors generate an output signal to the controller when the operator is within a predetermined proximity of the active drill head.

In one particularly preferred embodiment, the controller receives the output signal and generates a warning signal to the operator. Another option is for the control to disable the drilling or bolting machine upon receiving the output signal. In any event, the chance of the operator unknowingly approaching the drill head is substantially reduced.

Preferably, the transmitter comprises a wireless device for emitting the control signals received by the controller. The sensor may comprise a proximity detector for detecting one of the operator or the transmitter.

The system may further include a miner for advancing the mine passage. In such case, the transmitter may transmit the control signals from the operator at the remote location to control the miner. The controller upon receiving the output signal from the sensor may disable the operation of the miner or the drill module. Still another alternative is for the controller to disable the activation of any automated temporary support.

In accordance with another aspect of the invention, a system for assisting the operator in mining materials to form a mine passage having a face into which a borehole is formed for receiving a bolt to support for the face is provided. The system comprises a miner capable of advancing the mine passage and forming the face. A drilling module supported by the miner for drilling the face forms the borehole and installs the bolt therein to form the supported face. A transmitter transmits to the controller control signals for controlling at least the drilling module from the operator at a remote location from the drilling module and below the supported face. Preferably, the transmitter is wireless and also transmits control signals for controlling the miner.

Yet another aspect of the invention is a system assisting an operator in mining materials for forming a mine passage having a face and forming a borehole in the face for receiving a bolt. The system comprises a miner for advancing the mine passage and forming the face, as well as a drilling module for drilling the face to form the borehole and generating output signals representative of one or more drilling parameters. A controller is provided for receiving the one or more drilling parameters, determining a characteristic of the material forming the face based on the drilling parameters, and instructing the operation of the miner based on the characteristic. Preferably, the controller instructs the operation of the miner by displaying the characteristic of the material forming the face on a display for viewing by the operator.

Still a further aspect of the invention is a system for assisting an operator in mining materials for forming a mine passage having a face into which a borehole is formed for receiving a bolt. The system comprises a miner for advancing the mine passage and forming the face, as well as a drilling module for drilling the face to form the borehole and installing the bolt in the borehole during a first period of time. A controller is provided for controlling the miner to advance the mine passage a predetermined distance within a second period of time substantially matching the first period of time.

Another aspect of the invention is a system assisting an operator in mining materials for forming a mine passage having a face into which a borehole is formed for receiving a bolt. The system comprises a miner for advancing the mine passage and forming the face, as well as a drilling module for drilling the face to form the borehole and installing the bolt in the borehole. A controller is provided for controlling the miner, as is a transmitter for transmitting to the controller control signals from the operator at a remote location from the face. Sensor(s) sense when the operator is within a predetermined proximity of the miner and generate an output signal.

An additional aspect of the invention is a method of operating a mining machine with a drill head for use by an operator in forming a borehole in a face of a mine passage and installing a bolt therein. The method comprises, from a location remote from the drill head, operating the machine with the drill head to form the borehole. The method further comprises generating an output signal if the operator is within a predetermined proximity of the drill head.

In the case where the operating step comprises operating the machine to form the borehole adjacent a rib of the mine passage so as to create a gap between the machine and the rib, the method comprises generating the output signal when the gap is occupied. The method may further comprise stopping the machine if the operator occupies the gap. Alternatively, the operating step may comprise actuating a temporary support to engage the face, and the method includes stopping the machine from actuating the temporary support if the operator approaches the temporary support from the remote location, as determined by the output signal.

Yet an additional aspect of the invention is a method of assisting an operator in mining materials for forming a mine passage having a face. The method comprises drilling the face to form a borehole. Based on the drilling step, the method further comprises determining a characteristic of the material comprising the face. The mine passage is then advanced based on the characteristic (which may be a height of a first material that is soft relative to a second material forming the face, in which case the advancing step may comprise raising a cutter drum of a miner to mine substantially to the height of the first material).

Still another aspect of the invention is a method for assisting an operator in mining materials for forming a mine passage having a face into which a borehole is formed for receiving a bolt. The method comprises drilling the face to form the borehole and installing the bolt in the borehole during a first period of time, and advancing the mine passage in a second period of time substantially matching the first period of time. Preferably, the drilling step comprises drilling the borehole with a drilling module associated with a miner.

Another aspect of the invention is a method of mining a face in a mine passage, comprising forming an entry in the face using a mining machine. While forming the entry, the method includes installing roof support using a first bolter separate from and capable of passing by the mining machine in the entry. Preferably, the step of forming the entry comprises making a first cut into the mine face using the mining machine, withdrawing the mining machine from the passage formed during the first cut, and making a second, adjoining cut into the mine face using the mining machine (in which case the step of installing roof support is performed while making the second cut to complete the entry).

The invention in a different aspect comprises a method of mining a face in a mine passage. The method in this case includes the steps of forming a first entry in the face to a predetermined advance distance and then forming a second entry in the mine face adjoining the first entry to about the predetermined advance distance. While forming the second entry, roof support is installed in the first entry.

A further aspect of the invention is a method of mining a face in a mine passage, comprising: forming an entry in the face using a mining machine. The method comprises the step of installing roof support in the entry using first and second remotely controlled bolters. The method may further include the step of withdrawing the mining machine from the entry after the step of forming the entry but before the installing step. Preferably, the step of installing roof support comprises transmitting radio signals from a transmitter to a receiver associated with one of the first and second bolters.

### BRIEF DESCRIPTION OF THE DRAWINGS

FIG. 1 is a top plan schematic view of a mine entry including a mining machine and a separate bolting machine;

FIG. 1a is a top plan schematic view of a mine entry including two remotely controller bolting machines working in tandem;

FIGS. 2a-2d are front, rear, top, and side views of a bolting machine forming one aspect of the invention;

FIG. 3 is another top plan schematic view of a mine entry including a mining machine and a separate bolting machine;

FIG. 4 is a top plan schematic view of a mining machine including a miner incorporating a bolter with a pair of drilling modules;

FIG. 5 is a perspective schematic view of a display for use with a bolting or mining machine; and

FIG. 6 is a screen shot displaying a characteristic of the material forming the mine face.

### DETAILED DESCRIPTION OF THE INVENTION

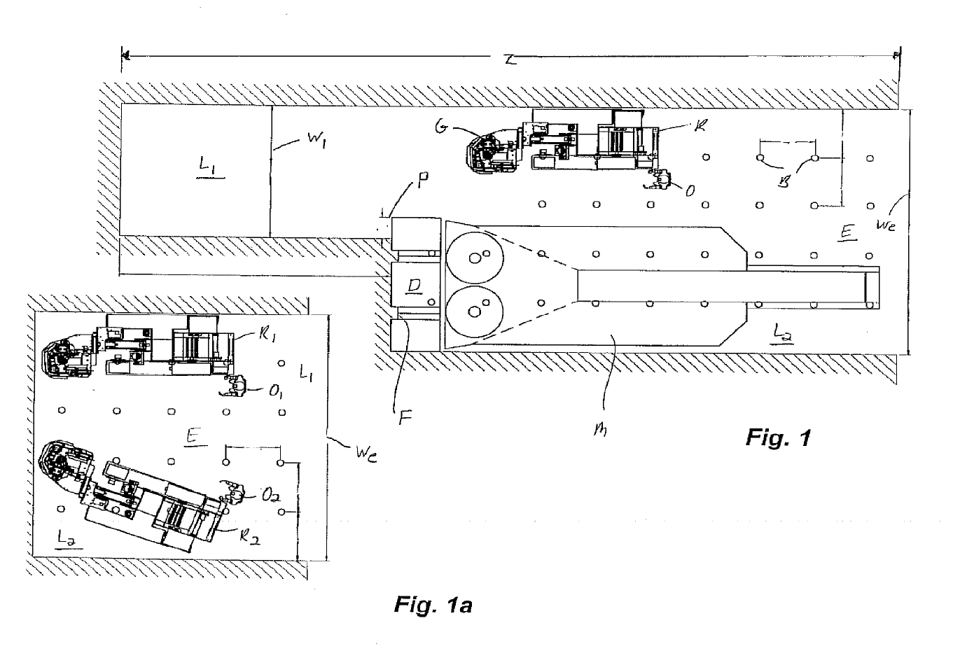

Reference is now made to FIG. 1, which is a top plan view schematically illustrating one aspect of the invention, which comprises an inventive mining method. This mining method applies in particular to underground mining involving a multiple, or “skip,” cut technique. Using this technique, a mining machine for advancing the mine passage, such as the exemplary continuous miner M having a rotary drum D shown in FIG. 1, is used to take a first cut, or “lift” L₁ from the working face F at a particular width W₁ (e.g., 130 inches) to an approved predetermined advance depth Z (which may vary depending on a host of factors). The miner M is then withdrawn from this passage serving as a portion of the entry E (which has already occurred in FIG. 1) thus formed. A second, adjoining cut or “lift” L₂ of a comparable width (e.g., 110 inches in FIG. 1, since an approximate overlap P of 20 inches is provided) is then taken during the next advance or pass. This second cut or lift L₂ widens and expands the hole to complete the entry E having a width Wₑ comprising the sum of the width of the two cuts (in FIG. 1, about twenty feet).

Rather than using a bolter associated with the miner M or installing bolts in the roof or rib(s) only once the miner is withdrawn from the entry E, one aspect of the inventive mining method shown in FIG. 1 involves simultaneously using at least one roof bolting machine or bolter R alongside the miner M in the same entry E to install roof bolts B in the prescribed pattern (e.g, in two spaced apart rows, about four feet apart). Consequently, in this particular embodiment, the bolter R operates separate from but in tandem and along a substantially parallel path with the miner M in the same entry E while it is being formed, instead of being used only once it is withdrawn from the completed entry E. Consequently, the bolter R installs bolts and provides support for the roof to “pass by” the mining machine while completing the entry E. As a result, the cycle time is reduced significantly and overall efficiency of the mining operation is improved.

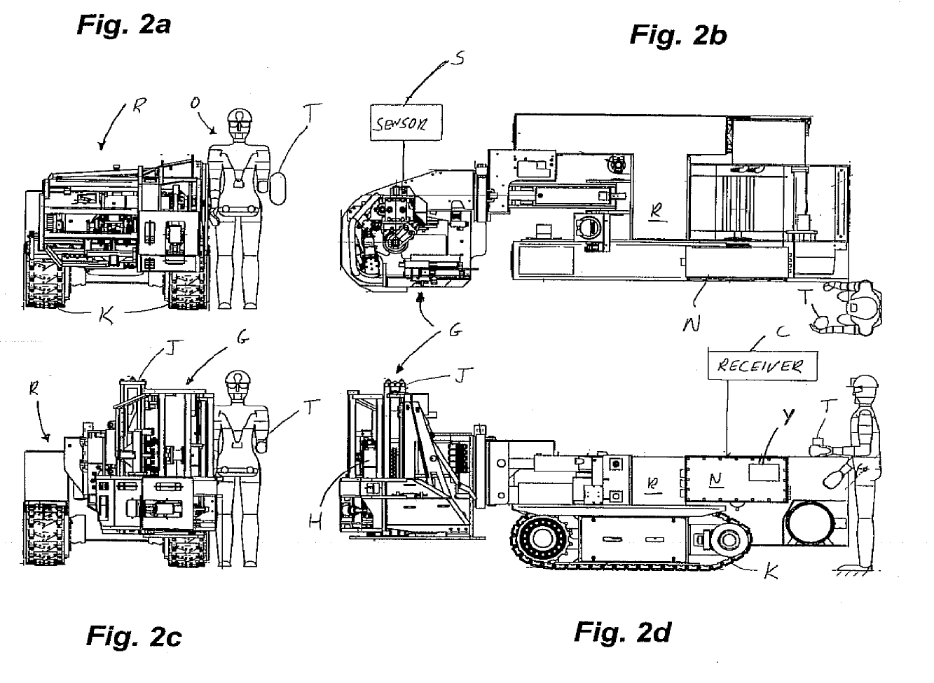

A further aspect of the invention is to operate the bolter R remotely. This can be done by an operator O standing alongside or adjacent the bolter R, as shown in FIG. 1, preferably under and adjacent the face in which bolts B have already been properly installed to provide the desired support. An onboard controller N is associated with controls that transmit control signals for the bolting operation (such as the raising and lowering of the drill head to complete the borehole and install bolts therein; see Applicant's International Patent Application No. PCT/US06/2191 8, the disclosure of which is incorporated herein by reference) may be located at the rear of the bolter R, under supported roof and thus remote from the front end performing the bolting operation under the unsupported roof (e.g., more than twelve feet removed, as shown in FIGS. 2a-2d). Alternatively, control from beneath the supported roof may be by way of control signals transmitted from a portable, handheld unit, or transmitter T, carried by the operator O to a receiver C associated with the bolter R (see FIGS. 2a-2d). In such case, the signals are preferably wireless, such as radiofrequency signals.

In either case, several advantages arise from the practice of this aspect of the invention. For one, the operator O is advantageously not constantly exposed to unsupported roof, as may be the case if the bolter R were manually operated and coupled to the miner M. Moreover, the operator O is not positioned ahead of or on the miner M, but rather behind it and to one side, relatively far away from the face and the drum D or other implement used for advancing the passage. Yet another advantage is providing the operator with the ability to operate the bolter R from the side of it facing away from the rib, which helps to protect from deleterious rib rolls.

Typically, air pressure (typically negative) is used to flush the cuttings and debris from the borehole during the drilling operation. A side benefit of removing the operator O from the immediate drilling area is that it becomes possible to use water to flush the borehole during drilling. Additionally, with the operator O removed, higher pressure water can be used for flushing. The benefits of higher pressure flushing may lead to a lesser volume of water being required to drill as compared to regular water-assisted drilling.

An exemplary bolter R for particular use in remote control operation of the type described above is shown in FIG. 2. As should be appreciated by a skilled artisan, the illustrated bolter R has no boom swing. Instead, hydraulic lift and tilt cylinders are used to raise, lower, and tilt the drill module G (which can include a rotary or percussive drill head H; see FIG. 2d). This results in a considerably more compact arrangement better able to maneuver in the confines of the entry E with the miner M present while making the adjoining cut.

Tramming of the bolter R about the entry E may be accomplished using ground engaging means, such as low profile crawler tracks K, and a corresponding drive motor. The tram function is also used to position the bolter R from side to side. Furthermore, one or more supports may be provided for engaging the face(s) of the mine passage prior to or during installation of the bolts. These operations, as well as operation of the drill module G to achieve the drilling and bolting function, can all be remotely controlled by the operator, as described in the foregoing passage.

As noted above, use of the remote control technique means that the operator should never be under unsupported roof during proper operation. Accordingly, the canopy and temporary roof support can be optionally deployed, as in the bolter R of FIG. 2, or altogether omitted. This not only helps to reduce the maintenance and construction costs, but also the overall efficiency of the operation.

In accordance with a further aspect of the invention, a sensor S may be provided to generate an output signal to the controller N to take automatic action (e.g., shut down the drilling functions and/or provide a warning) if the operator comes within a certain proximity to the bolter R forming the borehole in the unsupported roof from the remote location or if the transmitter T becomes positioned too closely to the drill module G incorporating the drill head H. This may be desirable to ensure compliance with regulations requiring the maintenance of a certain distance between the operator O and the drill module G during the drilling or bolting routine. The sensor S may comprise a receiver C (e.g., an RF receiver) that receives signals and thereby senses the position of the transmitter T carried by the operator 0. Alternatively, a proximity sensor may be used, such as one using infrared energy to detect the position of the operator O or transmitter T.

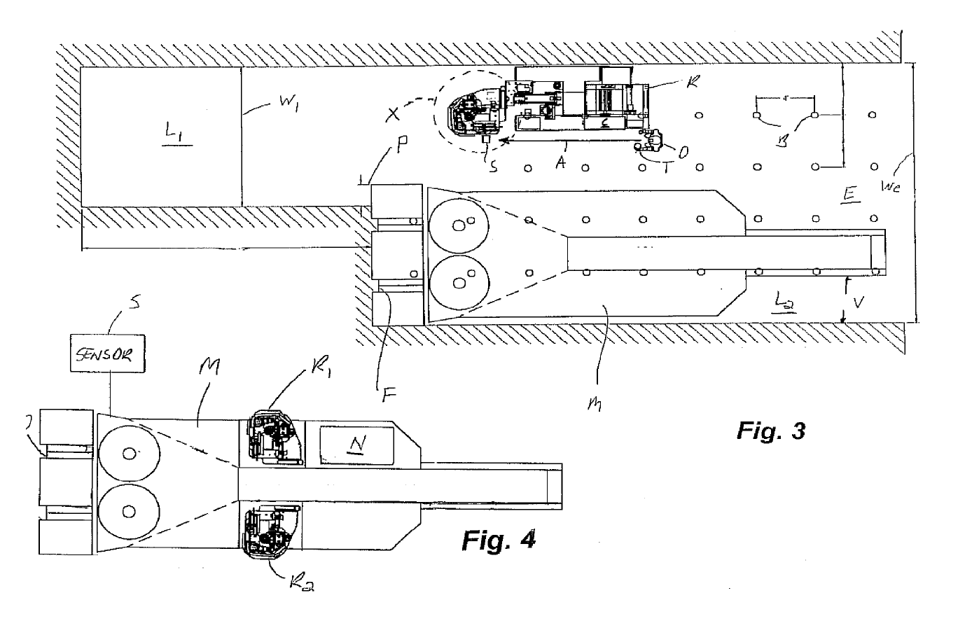

Accordingly, with reference to FIG. 3, the bolter R may be operated remotely, such as by using the operator-held transmitter T for delivering a control signal, such as a radio frequency signal transmitted wirelessly, to the receiver C. If the operator O should move within a predetermined proximity of the location adjacent the drill module G when the drilling or bolting operation is in progress (note action arrow A), the field of the sensor S (note representative illustration created by dashed line circle X) detects such, either by way of detecting a proximity signal or the proximity of the physical operator O. The sensor S may then generate an output signal, and appropriate measures are then taken by the controller N upon receiving the signal (such as from receiver C) to halt or disable the drill module G, such as by deactivating it. The module G may then remain in a locked out condition until the operator returns to the remote location.

Another possible application of this type of sensor arrangement can limit an operator's ability to operate any machine remotely from undesirable locations. For example, in the case of having one or more remote bolter R on the miner M itself to form a unitary mining machine, this type of sensor arrangement can be used to disable operation if the operator O remotely controlling was to move to an undesirable position (i.e., in the gap V between the machine and the rib; see FIG. 3). Likewise, in the case of a handheld transmitter T, the sensor arrangement could be used to prevent the bolter R from tramming to a position too close to the operator, as may be determined by the proximity of the sensor S to the transmitter T.

This type of sensor arrangement could also be used for disabling the miner M itself, should the operator O get within a predetermined proximity of the working face being mined. For example, the sensor S and controller N could form part of the miner M (see FIG. 4). The controller N preferably is arranged such that the operator O at all times remains under a supported (i.e., previously bolted) face of the mine passage. A transmitter T separate from the miner M could also be used to generate the control signals, as with the embodiment of the bolter R described in the foregoing discussion.

Likewise, if remote radio control is used on a conventional drilling or bolter with an automated temporary roof support (such as a stab jack J; see FIGS. 2c and 2d), the sensor S may detect whether the operator moves too close to the ATRS during actuation (deployment or retraction). If such an approach is detected, the operation may be automatically halted or ceased until the condition abates. As noted above, an option is to provide a visual or audible warning or alarm to alert the operator to the condition before halting or ceasing the operation.

In yet another aspect of the invention, and with reference to FIG. 1a, two bolters R₁, R₂ may work side-by-side in an entry E once formed, either by way of a full face cut or a skip cut made using the mining machine, such as the continuous drum miner M. In this way, the bolting may be performed with double the efficiency of past approaches employing only a single bolter per entry. Moreover, the different operators O using the remote control may both remain underneath supported roof at all times.

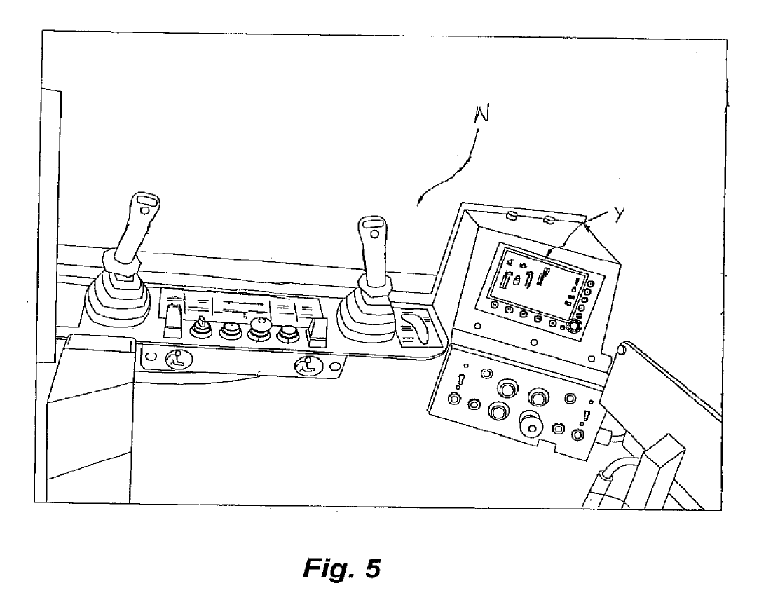

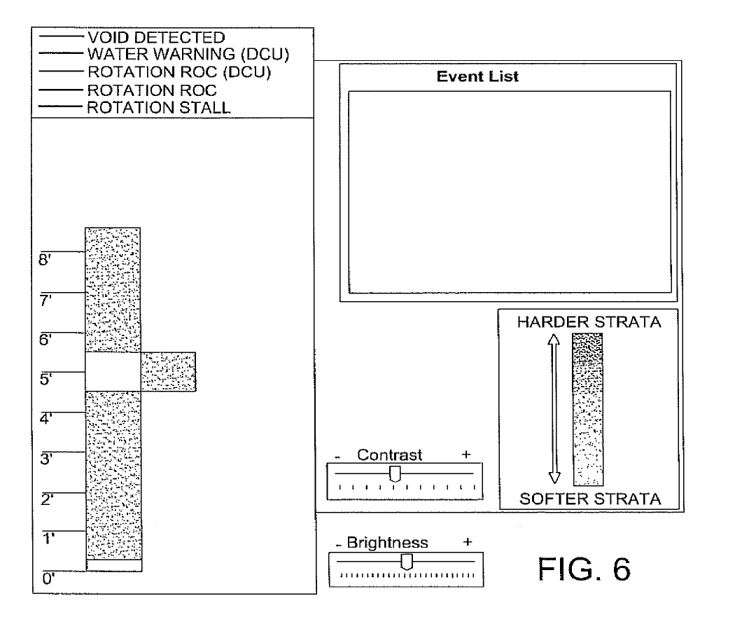

The drilling module G used with the bolter R of FIG. 2 may be that described in detail in Applicant's International Patent Application No. PCT/US06/2191 8. As described therein, the bolter R may associate with an information display Y, an example of which is shown by FIG. 5. In accordance with one particularly advantageous aspect of the invention, the drilling module G may employ a roof “mapping” program for generating a profile of the material forming the face and underlying strata (collectively, the face) being drilled, which may be visualized on the display Y (either as data or graphically, such as in the form of a two-dimensional representation of the elongated borehole; see FIG. 6).

The program may generate the profile of the material being drilled based on one or more drilling parameters. For example, during drilling, thrust and torque may be monitored using sensors (various types of which are known in the art) and used for determining the location of voids and fractures, since these parameters react sharply upon encountering such. Likewise, to identify the interface between adjacent layers (e.g., coal and rock), the rotational acceleration of the drill rotational speed can be used, since this speed is normally affected near the interface (depending on the rock types that the drill is drilling away or into softer or stronger rock). Changes in the feed or rotation rate for a given thrust may also be indicative of the relative hardness of the material being drilled. Additional details of an exemplary mapping program are provided in Applicant's U.S. Pat. No. 6,637,522, the disclosure of which is incorporated herein by reference.

As the bolter R forms a borehole B using the drilling module G, it may relay information about the face, such as characteristic of the material being drilled (that is, whether it is soft or hard based on the feed rate for a given level of thrust), back to the controller N for visualization on the display Y. Aside from being of value during the drilling operation and in connection with the development of a good roof control plan, this information on the characteristic may be used to instruct the operator O how to advance the miner M to maximize recovery while minimizing wear and tear.

Specifically, and by way of illustration only, the information displayed may instruct the operator O or a controller how high to raise the cutter drum D in order to maximize the coal recovery while avoiding contacting harder material overlying the coal (such as some types of rock). Thus, as shown on the exemplary screen shot of FIG. 6, it can be seen that a small portion of soft strata exists just above the exposed part of the face being drilled (the position of which may be known from the contact made between a drill steel or guide structure). Accordingly, the drum D may be raised during shearing to a height to recover this softer material. Since softer material, including coal, is easier to cut than harder material, this feature can advantageously be used to help reduce wear and tear on the miner M. Potentially avoiding excessive rock drilling also reduces dust and the costly measures required to control it in the underground environment.

In many cases, a bolt may take longer to install than the shear cycle of a mining machine, such as a drum miner M. If the drilling module G of a bolter R used to form the boreholes and install the bolts therein and the miner M together form part of a unitary mining machine movable about the mine passageways (as shown in FIG. 4 with two onboard bolters R₁ and R₂), the machine cannot advance until the bolt cycle is finished.

Thus, in accordance with a further aspect of the invention, the bolting operation could be tied to control the miner shear rate (that is, the rate at which the miner M shears the material). For example, if it takes a given amount of time in which to install one or more roof bolts (which may be empirically determined), as necessary to provide proper support, the shear rate of the miner M would be controlled to shear the next cut of material in a period that substantially matches the amount of time required for the bolting. Having the shear cycle and the bolt cycle time correspond provides a smother flow of cut material and produces less machine shock. This also may reduce the wear and tear on the miner M, and results in a more stable operation.

As a further aspect of the invention, the miner M and bolter R (whether combined or otherwise) may have interlocks that promote safety. For instance, the control could prevent the miner M from advancing or otherwise tramming when the operator is in an undesirable location, such as in the path, as detected by an associated proximity sensor S (see FIG. 4). Tramming of the miner M could also be locked out when an associated bolter R₁ or R₂ is actively bolting to prevent broken drill steels and bolts. Sensors, such as accelerometers, may also be provided to monitor the relative movement of the miner M, thereby further increasing stability.

As noted above, the remote and control aspects this design may be employed to eliminate the need for physical barriers to the roof and ribs, such as an ATRS (which may comprise any known device for engaging a face of a mine passage to provide temporary support). By reducing the need for such systems, the miner M incorporating the bolter R can be somewhat smaller and lighter, thereby improving maneuverability. This will also reduce machine complexity and improve maintainability.

The foregoing descriptions of various embodiments of the invention are provided for purposes of illustration, and are not intended to be exhaustive or limiting. Modifications or variations are also possible in light of the above teachings. The embodiments described above were chosen to provide the best application to thereby enable one of ordinary skill in the art to utilize the disclosed inventions in various embodiments and with various modifications as are suited to the particular use contemplated. All such modifications and variations are within the scope of the invention.

1. A system for assisting an operator in controlling a machine including a drill head for drilling a borehole in a face of a mine passage and installing a bolt therein, comprising:
a controller for controlling the operation of the drilling or bolting machine;
a transmitter for transmitting to the controller control signals from the operator at a remote location from the drill head; and
a sensor for generating an output signal to the controller when the operator is within a predetermined proximity of the drill head.

2. The system of claim 1, wherein the controller receives the output signal and generates a warning signal to the operator.

3. The system of claim 1, wherein the controller receives the output signal and disables the drilling or bolting machine.

4. The system of claim 1, wherein the transmitter comprises a wireless device for emitting; the control signals received by the controller.

5. The system of claim 1, wherein the sensor comprises a proximity detector for detecting one of the operator or the transmitter.

6. The system of claim 1, further including a miner for advancing the mine passage, and wherein the transmitter transmits the control signals from the operator at the remote location to control the miner.

7. The system of claim 1, further including a miner associated with the machine for advancing the mine passage, and wherein the transmitter transmits the control signals from the operator at the remote location to control the miner.

8. The system of claim 7, wherein the controller upon receiving the output signal disables the operation of the miner.

9. The system of claim 1, wherein the controller upon receiving the output signal disables the drill head.

10. The system of claim 1, further including an automated temporary support for engaging the face, and wherein the controller disables the automated temporary support after the output signal is received.

11. A system assisting an operator in mining materials for form a mine passage having a face into which a borehole is formed for receiving a bolt to provide support for the face, comprising:
a miner capable of advancing the mine passage and forming the face;
a drilling module supported by the miner for drilling the face to form the borehole and installing the bolt therein to form the supported face;
a transmitter for transmitting to the controller control signals for controlling at least the drilling module from the operator at a remote location from the drilling module and below the supported face.

12. The system of claim 11, wherein the transmitter comprises a wireless device for emitting signals received by the controller.

13. The system of claim 11, wherein the transmitter transmits control signals for controlling the miner.

14. A system assisting an operator in mining materials for forming a mine passage having a face and forming a borehole in the face for receiving a bolt, comprising:
a miner for advancing the mine passage and forming the face;
a drilling module for drilling the face to form the borehole and generating output signals representative of one or more drilling parameters; and
a controller for receiving the one or more drilling parameters, determining a characteristic of the material forming the face based on the drilling parameters, and instructing the operation of the miner based on the characteristic.

15. The system according to claim 14, wherein the miner and the drilling module are physically connected.

16. The system according to claim 14, wherein the drilling module comprises a rotational drill head, and the drilling parameters comprise thrust or torque.

17. The system according to claim 14, wherein the controller instructs the operation of the miner by displaying the characteristic of the material forming the face on a display for viewing by the operator.

18. A system assisting an operator in mining materials for Conning a mine passage having a face into which a borehole is formed for receiving a bolt, comprising:
a miner for advancing the mine passage and forming the face;
a drilling module for drilling the face to form the borehole and installing the bolt in the borehole during a first period of time and
a controller for controlling the miner to advance the mine passage a predetermined distance within a second period of time substantially matching the first period of time.

19. A system for assisting an operator in mining materials for forming a mine passage having a face into which a borehole is formed for receiving a bolt, comprising:
a miner for advancing the mine passage and forming the face;
a drilling module for drilling the face to form the borehole and installing the bolt in the borehole;
a controller for controlling the miner;
a transmitter for transmitting to the controller control signals from the operator at a remote location from the face; and
a sensor for sensing when the operator is within a predetermined proximity of the miner and, generating an output signal.

20. The system according to claim 19, wherein the transmitter transmits signals to control the drilling module.

21. The system according to claim 19, wherein the sensor comprises an infrared proximity detector for detecting the proximity of one of the operator or the transmitter.

22. A method of operating a mining machine with a drill head for use by an operator in forming a borehole in a face of a mine passage and installing a bolt therein, comprising:
from a location remote from the drill head, operating the machine with the drill head to form the borehole; and
determining if the operator is within a predetermined proximity of the drill head.

23-25. (canceled)

26. A method of assisting an operator in mining materials for forming a mine passage having a face, comprising:
drilling the face to form a borehole:
based on the drilling step, determining a characteristic of the material comprising the face; and
advancing the mine passage based on the characteristic,

27. (canceled)

28. A method for assisting an operator in mining materials for forming a mine passage having a face into which a borehole is formed for receiving a bolt, comprising:
drilling the face to form the borehole and installing the bolt in the borehole during a first period of time; and
advancing the mine passage in a second period of time substantially matching the first period of time.

29. (canceled)

30-37. (canceled)

38. A method of mining a face in a mine passage, comprising:
forming a first entry in the face to a predetermined advance distance;
forming a second entry in the mine face adjoining the first entry to about the predetermined advance distance;
while forming the second entry, installing roof support in the first entry.

39-43. (canceled)
